(19) United States
(12) Patent Application Publication
(10) Pub. No.: US 2024/0384699 A1
(43) Pub. Date: Nov. 21, 2024

(54) DIFFUSER AUGMENTED WIND TURBINE WITH BLOCKAGE MECHANISM AND METHOD THEREOF

(71) Applicant: Vishak Jambu Nathan, Bangalore (IN)

(72) Inventor: Vishak Jambu Nathan, Bangalore (IN)

(21) Appl. No.: 18/693,166

(22) PCT Filed: Nov. 14, 2022
(86) PCT No.: PCT/IN2022/050998

§ 371 Date: Mar. 19, 2024

(30) Foreign Application Priority Data
Nov. 26, 2021 (IN) 202141054677

(51) Int. Cl. F03D 1/04

(52) U.S. Cl. CPC F03D 1/048; F03D 1/042

(57) ABSTRACT

The present invention generally relates to the field of energy generation systems-renewable energy—wind energy and flowing water energy, more particularly to the fluid turbines. The present invention uses the blockage effect either due to a plate or due to a ground suitably place so that in a distance up to one diameter away from the duct, so that the air is deflected up to 90 degrees and beyond and the flow rate through the duct and turbine is increased, leading to higher efficiency and greater power produced.

### FIELD OF THE INVENTION

The present invention generally relates to the field of energy generation systems-renewable energy—wind energy and flowing water energy, more particularly to the fluid turbines. The present invention gives a system and method for diffuser augmented wind turbine comprising blockage mechanism.

### BACKGROUND OF THE INVENTION

Shrouded/diffuser wind turbines were a subject of serious research until the mid-1980s. However, the relationship between the amount of material required for the diffuser and the area of the diffuser opening did not allow the shrouded wind turbines to grow in size. In addition, as the shroud increased in size, the wind drags on the shroud increased as well, requiring strong support towers. The conventional open wind turbines could be increased in size far more easily and as the technology for the same matured, the horizontal axis wind turbine with three blades came to be adopted as the industry standard.

In wind turbines enclosed in a shroud/diffuser, commonly known as Diffuser Wind Turbines, the efficiency of the turbines and hence energy produced increases when the velocity fluid flowing across the turbine is increased. This is done by having an angled flange at the exit of the diffuser to generate a vortex at the exit which thereby lowers the ambient pressure at the exit, thereby increasing the flow velocity through the diffuser.

U.S. Pat. No. 9,932,959B2 relates to a system, a method, and an apparatus of diffuser nozzle augmented wind turbine. In one embodiment, a method includes attaching a nozzle with a streamlined opening to a diffuser to direct an air flow into a wind turbine. In addition, the method includes increasing a wind speed approaching a set of turbine blades within a shrouded wind turbine configuration. The method also includes recirculating the air within the shroud configuration to increase an output power generated through the wind turbine. The system is composed of diffuser and nozzle integrated and non-integrated with and without a flange. In one embodiment, a method includes increasing a pressure differential of a wind turbine.

U.S. Pat. No. 8,487,470B2 relates to a vertical wind turbine is provided that includes a support base defined about an axis, a bearing assembly, a drive shaft having a proximal end and an opposing distal end, and a multistage axial flux generator. The bearing assembly includes a fixed ring and a rotating ring, wherein the fixed ring is coupled to the support base. The drive shaft is coupled to the rotating ring of the bearing assembly, and a plurality of sails are coupled to the drive shaft. The multistage axial flux generator includes a rotor assembly coupled to the drive shaft and a stator assembly coupled to the support base. The rotor assembly includes a plurality of permanent magnets, and the stator assembly includes a plurality of coils defining at least two voltage output stages. The permanent magnets on the rotor assembly are close coupled to the coils on the stator assembly.

US2012256424A1 relates to an apparatus and system for increasing power output for wind energy generation through a diffusing mechanism. An apparatus and system for mixing the wake and external flow, thereby permitting increasing mass-flux for wind energy generation. An apparatus to control and energize the boundary layer associated with wind energy generation by the use of an intake, bypass, and diffuser mechanism. A distributed load support provided by a wind energy generation apparatus and system. An apparatus for augmenting a wind energy generation system by achieving an increased energy extraction per unit of primary mass-flow.

For the above prior arts having a flange at the exit of the diffuser to generate a vortex to lower the pressure at the exit.

Accordingly, there exists a need for a diffuser augmented wind turbine using blockage effect.

### OBJECTS OF INVENTION

It is the primary object of the present invention to provide a diffuser augmented wind turbine system with power generation via blockage unit mechanism.

It is another object of the present invention to provide an increased efficiency diffuser turbine using blockage effects.

It is another object of the present invention to provide a blockage enhanced turbine.

It is another object of the present invention to provide the blockage unit is configured to block the flow of air from the diffuser and forces it to flow out in a direction tangential to the direction of exit out of the diffuser.

It is another object of the present invention to provide a diffuser augmented wind turbine system, wherein the diffuser comprises of a horizontal diffuser, a vertical diffuser and the like.

It is another object of the present invention to provide a diffuser augmented wind turbine system, wherein the blockage unit comprises of a blocking sheet, a ground, physical sheet, and the like.

It is another object of the present invention to provide a diffuser augmented wind turbine system, wherein the blockage mechanism is configured to create a blockage effect either due to a plate or due to a ground or suitable place and the air is deflected up to 90 degrees and beyond and the flow rate through the diffuser and turbine is increased, leading to higher efficiency and greater power produced than other wise.

It is another object of the present invention to provide a diffuser augmented wind turbine system, wherein due to the blockage to the airflow and due to the carefully placed barrier to the flow, the flow expands to a greater area than otherwise and due to the flow being turned by a large angle, the induced velocity in the turbine is increased.

It is another object of the present invention to provide a method of working of the diffuser augmented wind turbine system, wherein the distance between the blockage and the diffuser exit is such that the blockage effect is felt at the diffuser exit and the efficiency of the turbine is increased.

It is another object of the present invention to provide a method of working of the diffuser augmented wind turbine system, wherein due to turning of the fluid flow by a large angle up to 90 degrees and beyond, the diffuser exit experiences lowered pressure and the airflow rate through the turbine increases resulting in higher power produced.

### SUMMARY OF THE INVENTION

One or more of the problems of the conventional prior art may be overcome by various embodiments of the present invention.

It is the primary object of the present invention to provide a diffuser augmented wind turbine system with blockage mechanism, comprising:
a duct with an inlet;
a turbine;
a diffuser; and
a blockage unit,
   wherein the blockage unit is configured to block the flow of air from the diffuser and forces it to flow out in a direction tangential to the direction of exit of the diffuser.

It is another object of the present invention, wherein the diffuser comprises of a horizontal diffuser, a vertical diffuser and the like.

It is another object of the present invention, wherein the blockage unit comprises of a blocking sheet, a ground, physical sheet, and the like.

It is another object of the present invention, wherein the blockage effect either due to a plate, or the ground, suitably placed so that a distance away from the duct and the air is deflected up to 90 degrees and beyond so that flow rate through the diffuser and turbine is increased, leading to higher efficiency and greater power produced.

It is another object of the present invention, wherein the blockage effect to the airflow and due to the carefully placed barrier to the flow, the flow expands to a greater area than otherwise and due to the flow being turned by a large angle, the induced velocity in the turbine is increased.

It is another aspect of the present invention, a method of working of the diffuser augmented wind turbine system with blockage mechanism, comprising:
entering of the fluid into the diffuser inlet;
   wherein the fluid is air, water and the like,
flowing of the fluid over the turbine;
exhausting of the fluid via the diffuser onto a blockage unit; and
blocking of the flow of fluid and forcing it out in a direction tangential to the direction of exit out of the diffuser.

It is another aspect of the present invention, wherein the turning effect of the fluid flow by a large angle up to 90 degrees and beyond, the diffuser exit experiences lowered pressure and the airflow rate through the turbine increases resulting in higher power produced.

### BRIEF DESCRIPTION OF THE DRAWINGS

The manner in which the features, advantages and objects of the invention, as well as others which will become apparent, may be understood in more detail, more particular description of the invention briefly summarized above may be had by reference to the embodiment thereof which is illustrated in the appended drawings, which form a part of this specification. It is to be noted, however, that the drawings illustrate only a preferred embodiment of the invention and is therefore not to be considered limiting of the invention's scope as it may admit to other equally effective embodiments.

FIG. 1: illustrates the schematic flow diagram of the diffuser augmented wind turbine system with blockage mechanism according to one embodiment of the present invention.

FIG. 2: illustrates the schematic block diagram of the horizontal diffuser of the diffuser augmented wind turbine system with blockage sheet according to one embodiment of the present invention.

FIG. 3: illustrates the schematic block diagram of the vertical diffuser of the diffuser augmented wind turbine system directed to the ground according to another embodiment of the present invention.

### DETAILED DESCRIPTION OF THE INVENTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The present invention generally relates to the field of energy generation systems-renewable energy—wind energy and flowing water energy, more particularly to the fluid turbines. The present invention gives a system and method for diffuser augmented wind turbine comprising blockage mechanism.

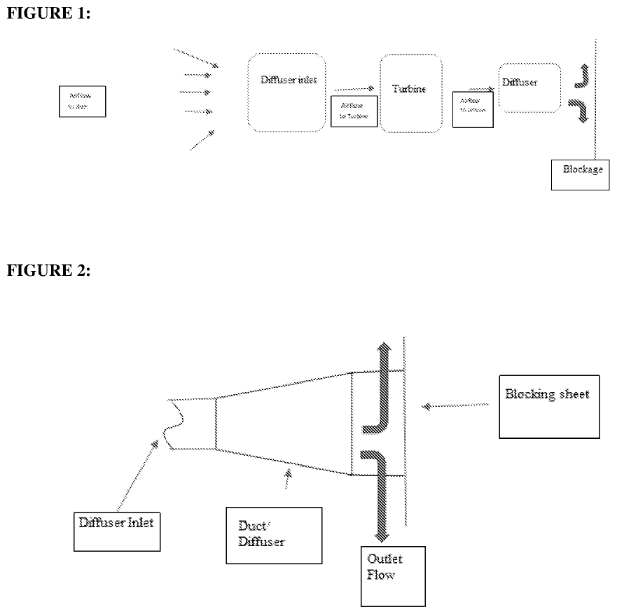

FIG. 1 illustrates the schematic flow diagram of the diffuser augmented wind turbine system with blockage mechanism, in accordance with an embodiment of the present invention. the fluid (air or water) enters the duct inlet, flows over the turbine, exhaust via the diffuser onto a sheet or on to the ground which blocks the flow of air and forces it out in a direction tangential to the direction of exit out of the diffuser.

The distance between the blockage and the diffuser exit is between half to two diffuser diameter away ie (d/2<H<2 d), where “d” is the diameter of diffuser and H is the distance between the diffuser and the blockage.

Due to turning of the fluid flow by a large angle of up to 90 degrees and beyond, the diffuser exit experiences lowered pressure and the airflow rate through the turbine increases resulting in higher power produced.

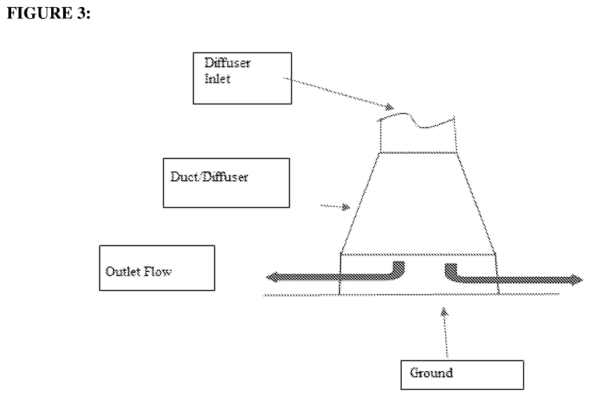

FIG. 2 illustrates the schematic block diagram of the horizontal diffuser of the diffuser augmented wind turbine system with blockage sheet in accordance with an embodiment of the present invention. This invention uses the blockage effect either due to a plate or due to a ground (as shown in the FIGS. 2 and 3) or suitable place, so that the air is deflected up to 90 degrees and beyond and the flow rate through the diffuser and turbine is increased, leading to higher efficiency and greater power produced than other wise.

The turbines are provided with using blockage effect (either due to a plate or ground) to increase the flow rate and efficiency of shrouded/diffuser turbines.

Due to “Ground effect “in helicopter and airplanes, it is well known that when they fly just at a distance of less than the rotor diameter and half the span of the wings respectively above the ground, they experience extra “lift” and that the power demanded from the engines reduces. The same principle is applied in “reverse” in the present invention, where due to the blockage to the airflow and due to the carefully placed barrier to the flow (can be ground or a physical sheet) (as shown in the FIGS. 2 and 3), the flow expands to a greater area than otherwise and due to the flow being turned by a large angle, the induced velocity in the turbine is increased, that results in greater efficiency (ie coefficient of power Cp of the turbine increases), resulting in higher energy produced than otherwise.

### Advantages:

The present invention is clearly advantageous in providing a technical solution to the problems of the prior art.
Higher velocity of flow in the diffuser and turbine results in higher efficiency over a diffuser turbine without the invention.
Greater velocity increase in the diffuser is possible with the diffuser augmented wind turbine than in the flanged diffuser turbine that exists.

At the outset of the description that follows, it is to be understood that the ensuring description only illustrates a particular form of this invention. However, such a particular form is only an exemplary embodiment and is not intended to be taken restrictively to imply any limitation on the scope of the present invention.

We claim:

1. A diffuser augmented wind turbine system with blockage mechanism, comprising:
a duct with an inlet;
a turbine;
a diffuser; and
a blockage unit,
wherein the blockage unit is configured to block the flow of air from the diffuser and forces it to flow out in a direction tangential to the direction of exit of the diffuser.

2. The diffuser augmented wind turbine system as claimed in claim 1, wherein the diffuser comprises of a horizontal diffuser, a vertical diffuser and the like.

3. The diffuser augmented wind turbine system as claimed in claim 1, wherein the blockage unit comprises of a blocking sheet, a ground, physical sheet, and the like.

4. The diffuser augmented wind turbine system as claimed in claim 1, wherein the blockage effect either due to a plate, or the ground, suitably placed so that a distance away from the duct and the air is deflected up to 90 degrees and beyond so that flow rate through the diffuser and turbine is increased, leading to higher efficiency and greater power produced.

5. The diffuser augmented wind turbine system as claimed in claim 1, wherein the blockage effect of the airflow and due to the carefully placed barrier to the flow, the flow expands to a greater area than otherwise and due to the flow being turned by a large angle, the induced velocity in the turbine is increased.

6. A method of working of the diffuser augmented wind turbine system with blockage mechanism, comprising:
entering of the fluid into the diffuser inlet;
wherein the fluid is air, water and the like,
flowing of the fluid over the turbine;
exhausting of the fluid via the diffuser onto a blockage unit; and
blocking of the flow of fluid and forcing it out in a direction tangential to the direction of exit out of the diffuser.

7. The method of working of the diffuser augmented wind turbine system as claimed in claim 6, wherein the turning effect of the fluid flow by a large angle of up to 90 degrees and beyond, the diffuser exit experiences lowered pressure and the airflow rate through the turbine increases resulting in higher power produced.
